(19) United States
(12) Patent Application Publication
(10) Pub. No.: US 2026/0030541 A1
(43) Pub. Date: Jan. 29, 2026

(54) ADAPTIVE ARTIFICIAL INTELLIGENCE MODEL FRAMEWORK

(71) Applicant: PayPal, Inc., San Jose, CA (US)

(72) Inventors: Meng Bai, Shanghai (CN); Jiaqi Zhang, Shanghai (CN); Lidong Ge, Shanghai (CN); Xue Zhang, Shanghai (CN); Yan Zhang, Shanghai (CN); Zelong Geng, Shanghai (CN)

(21) Appl. No.: 18/783,096

(22) Filed: Jul. 24, 2024

(51) Int. Cl. G06N 20/00

(52) U.S. Cl. CPC G06N 20/00

(57) ABSTRACT

Methods and systems are presented for providing an artificial intelligence (AI) model framework that uses an AI model to assist a machine learning (ML) model in classifying data, such that data corresponding to emerging patterns unrecognizable by the ML model can be classified accurately. Emerging patterns that are not recognizable by the ML model are detected. Representations of the emerging patterns are generated and provided to the AI model along with data to be classified in a prompt. The AI model is configured to use the ML model to classify the data if the data does not correspond to the emerging pattern. The AI model is further configured to use the representations to classify the data without using the ML model if the data corresponds to the emerging pattern.

### BACKGROUND

The present specification generally relates to a machine learning model framework, and more specifically, to providing a framework that enables machine learning models to adapt to new patterns according to various embodiments of the disclosure.

### RELATED ART

Machine learning models have been widely used by different entities to perform various tasks. For example, a classification system may use one or more machine learning models for classifying transactions (e.g., determining whether a transaction is a legitimate transaction or a fraudulent transaction, determining whether a transaction complies with a set of policies or not, etc.). While a machine learning model can be effective in learning patterns, the accuracy of its predictions is highly dependent on the quality of training data provided to the model. When new data that is fed to the machine learning model follows the same pattens that were learned by the machine learning model during the training process, the machine learning model can perform the prediction task with an acceptable accuracy (e.g., above a threshold). On the other hand, when the new data does not follow the patterns that were learned by the machine learning model, the accuracy performance of the model may suffer.

Since tactics in performing fraudulent transactions electronically are ever-evolving, fraudulent transactions may not always follow the same patterns, and new patterns may occur very frequently. Thus, it is important that the classification system to quickly adapt to new patterns that emerge such that the accuracy performance in classifying transactions can be maintained. Conventionally, machine learning models may undergo reconfigurations (e.g., modifying the input features, modifying parameters within the machine learning model, etc.) and retraining (e.g., using training data that corresponds to the newly emerged pattern, etc.) to adapt to newly emerged patterns. However, such a process often requires a substantial amount of computer resources and time (e.g., several days, several weeks, etc.) to complete. As a result, the adaptation of the machine learning models is often not quick enough to keep pace with the evolving fraud tactics, which can result in loss of funds for a user or merchant, exposure of personal data or information, and other adverse consequences of processing a fraudulent transaction. Thus, there is a need for a more efficient computer framework for maintaining and improving the accuracy performance of a classification system.

### BRIEF DESCRIPTION OF THE FIGURES

FIG. 1 is a block diagram illustrating an electronic transaction system according to an embodiment of the present disclosure;

FIG. 2 is a block diagram illustrating a classification module according to an embodiment of the present disclosure;

FIG. 3 illustrates an example data flow for classifying data according to an embodiment of the present disclosure;

FIG. 4 is a flowchart showing a process of generating a representation of an emerging pattern according to an embodiment of the present disclosure;

FIG. 5 is a flowchart showing a process of processing a transaction according to an embodiment of the present disclosure;

FIG. 6 is a flowchart showing a process of classifying a transaction using an artificial intelligence model framework according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing an artificial intelligence model framework that uses an artificial intelligence (AI) model to assist one or more machine learning (ML) models in classifying data (e.g., classifying transactions, classifying users, etc.), such that the ML models can quickly adapt to emerging patterns. As used herein, ML models are computer-based models that are capable of performing tasks (e.g., predicting a classification, etc.) based on learned patterns through one or more training processes. An ML model may include computer software structures, such as computer data structures (e.g., nodes, trees, etc.), and computer logic structures (e.g., algorithms, heuristics, etc.) that are associated with or implemented within the computer data structures. The computer software structures may also include parameters that are adjustable for determining one or more output values for the ML model. The computer software structures of an ML model enable the ML model to learn patterns associated with training data during the training process. Specifically, through one or more training processes, the ML model may perform self-modifications (e.g., modifications of the different parameters) to learn patterns from the training data in order to improve the prediction performance (e.g., a classification prediction, etc.) of the ML model. Typically, both the input(s) and output(s) of an ML model have fixed formats. For example, when an ML model is configured to classify transactions, the ML model may be configured to accept one or more specific types of input values, such as specific attributes associated with an electronic transaction, etc., and configured to generate one or more specific types of output values, such as one or more classification probabilities, etc. Example ML models include an artificial neural network, a gradient boosting tree, etc.

An AI model is similar to an ML model in that it also includes computer software structures capable of learning patterns (e.g., self-modifications through one or more training processes). However, an AI model is typically substantially more complex than an ML model. For example, an AI model typically includes millions or even billions of parameters, as opposed to thousands of parameters typically included in an ML model. The increased complexity enables the AI model to be more flexible than the ML model, at a cost of increased consumption of computer processing resources. In some embodiments, an AI model is capable of accepting input values in any format, and is also capable of generating output values in any format. For example, an AI model can be configured to interpret any phrases, sentences, inquiries, etc. in a natural language format (or in any language format). The AI model can also be configured to generate outputs in any free-form natural language format (or language of any types, such as programming languages, application programming interface (API) calls to other computer modules, etc.). As such, an AI model can be used to facilitate communications with humans or other computer modules in their native languages/interfaces without requiring any customization to the AI model. Example AI models include deep machine learning models, large language models, small language models, etc.

As discussed herein, while ML models are capable of performing classification tasks with a satisfactory accuracy level (e.g., above an accuracy threshold), they are relatively inflexible as their performance is closely tied to the knowledge (e.g., transaction patterns, etc.) that they learned through the training processes. When new data that is fed to the ML model follows the pattens that were learned by the ML model during the training processes, the ML model can perform the prediction task with an acceptable accuracy (e.g., above the accuracy threshold). On the other hand, when the new data does not follow the patterns that were learned by the ML model, the accuracy performance of the ML model may suffer and fall below an acceptable accuracy threshold.

As such, according to various embodiments of the disclosure, an AI model framework may provide an AI model to work with one or more ML models to perform classification tasks for a classification system of a service provider. The classification system may include the AI model that is configured to receive a query associated with performing a prediction task, such as for classifying a transaction, classifying a user, etc. The AI model may process the query by performing the classification task (e.g., classifying the transaction, etc.) without using any one of the ML models, or using at least one of the one or more ML models for performing the classification task.

In some embodiments, each one of the one or more ML models may be configured and trained to perform the classification task. In some embodiments, each of the ML models may include different computer structures (e.g., different types of artificial neural networks, etc.) and/or may be trained using different training data such that each ML model may learn different patterns (e.g., different types of fraudulent transaction patterns, etc.). For example, each ML model may be trained using training data associated with a different time period. In another example, each ML model may be trained using training data associated with a different fraud tactic. Based on the training processes conducted for the ML models, the ML models are capable of classifying transactions (or other types of data) that follow the patterns learned by the ML models during the training processes accurately (e.g., above the accuracy threshold). However, when a transaction is conducted using a different tactic that what was used before (e.g., a newly emerging pattern), the ML models may not be capable of accurately classifying the transaction.

As such, in some embodiments, the classification system may use the AI model to assist in the classification of transactions that correspond to one or more emerging patterns that are not recognizable by the one or more ML models. For example, as the classification system receives a request to classify a transaction, the classification system may provide data related to the transaction to the AI model. The data may include attributes associated with the transaction, such as an amount of the transaction, a transaction type (e.g., a login transaction, a purchase transaction from a merchant, a peer-to-peer payment transaction, a dispute transaction, etc.), identities of the parties involved in the transaction, device attributes (e.g., a network address, a screen resolution, a model, a software version, etc.) of the devices used to conduct the transaction, a time of day when the transaction is initiated, any addition data such as text (e.g., a reason for the dispute, etc.) or multimedia files provided by a user for the transaction, and other information related to the transaction. The classification system may also retrieve other data that is relevant (e.g., data the AI model is configured to consider) in classifying the transaction. The other data that is relevant to the transaction may include user data associated with one or more of the parties involved in the transaction (e.g., an age, a gender, an interest profile, etc.), historic transaction data associated with past transactions conducted through a user account involved in the transaction, and/or other information. The classification system may provide the data to the AI model.

Since the transaction to be classified may correspond to an emerging pattern that is not recognizable by any of the ML models, the classification system of some embodiments may also derive pattern information associated with one or more emerging patterns, and provide the pattern information to the AI model. The pattern information may be referred to a representation of the one or more emerging patterns, and may be derived based on different data sources. For example, a human analyst or a computer module (e.g., the classification system, etc.) may monitor transactions conducted through the service provider. By monitoring the transactions conducted through the service provider, the human analyst or the computer module may derive patterns from some of the transactions. The human analyst or the computer module may also determine whether a new pattern associated with recently conducted transactions has emerged.

In one embodiment, the computer module performs or accesses one or more clustering analyses to the recent transactions conducted with the service provider. Based on the analyses, the computer module determines that one or more clusters of transactions are associated with suspicious activities (e.g., subsequently labeled as fraudulent transactions, etc.). The computer module then determines whether the one or more clusters of transactions corresponds to old or known patterns (e.g., patterns that are recognized by the ML models). For example, if at least a portion of the transactions within the one or more clusters have been classified by the ML models incorrectly (e.g., initially classified by the ML models as non-fraudulent transactions, but subsequently determined to be fraudulent transactions based on review by a human analyst or by a subsequent event associated with the transactions, initially classified by the ML models as fraudulent transactions, but subsequently determined to be non-fraudulent transactions, etc.), the computer module may determine that the one or more clusters of transactions correspond to an emerging pattern not recognized by or used to train the ML models. The computer module may then identify the one or more clusters of transactions as transactions that are related to the emerging pattern. When a new pattern is detected, the classification system generates pattern information associated with the emerging pattern. For example, the classification system may obtain transactions conducted with the service provider that are related to the emerging pattern (e.g., the transactions within the one or more clusters). The classification system then generates a representation of the transactions (e.g., a summarization of the transactions, etc.) that are related to the emerging pattern.

In some embodiments, the classification system analyzes the transactions that are related to the emerging pattern, and selects a subset of the transactions that are representative of the emerging pattern (e.g., transactions may also have distinctive characteristics, such as transactions that have distinct attribute values from each other, transactions that have attribute values closer to the average of the transactions related to the emerging pattern, etc.). Since the transactions that correspond to the emerging pattern may be of different classifications, the classification system may group the transactions into different groups based on the classifications, and may generate the pattern information for the different groups. For example, the classification system may generate embeddings (e.g., vectors within a multi-dimensional space, etc.) based on each group of the selected transactions, such that the embeddings may accurately represent different aspects of the emerging pattern.

In some embodiments, the classification system analyzes the attribute values of the transactions that are related to the emerging pattern and classified as the different classification types. The classification system may derive different pattern information associated with the emerging pattern based on the attribute values, such as ranges or categories associated with one or more of the attributes (e.g., a range of network addresses, one or more countries from which the transaction is initiated, a software model/version, a range of transaction amounts, etc.) associated with each classification type. In some embodiments, the classification system then generates embeddings based on the pattern information.

In some embodiments, the classification system provides the embeddings to the AI model in addition to the data related to the transaction. For example, the classification system may generate a prompt for the AI model based on the classification request, the prompt including the data associated with the transaction (e.g., transaction attributes, etc.), the data related to the transaction (e.g., user attributes, historic transactions, etc.), and the embeddings. By providing the representation of the emerging pattern (e.g., in the form of embeddings, etc.) to the AI model, the AI model is able to learn and classify the transaction based on the emerging pattern.

In some embodiments, as the AI model receives the prompt, the AI model first determines whether the transaction corresponds to the emerging pattern. For example, the AI model analyzes the transaction (e.g., the attribute values associated with the transaction), and determines whether the transaction corresponds to the emerging pattern. If the AI model determines that the transaction does not correspond to the emerging pattern, the AI model instructs one or more ML models to classify the transaction. For example, the AI model may generate an application programming interface (API) call (e.g., a function call, etc.) for the one or more ML models. The API call may include the data associated with and/or related to the transaction. The AI model may then transmit the API call to the one or more ML models, to instruct the one or more ML models to classify the transaction.

The one or more ML models may generate an output that indicates a classification of the transaction. Upon receiving the output, the AI model may generate a response to the query (e.g., the classification request, etc.) based on the output, and may provide the response to a requesting module (e.g., the module that submitted the classification request). In some embodiments, the response includes a value or a phrase in a natural language.

On the other hand, if the AI model determines that the transaction corresponds to the emerging pattern, the AI model may perform a classification prediction for the transaction based on the data related to the transaction and the data that represents the emerging pattern (e.g., the embeddings, etc.), without using the one or more ML models. For example, the AI model may also generate embeddings based on the attribute values associated with the transaction, and may compare the embeddings of the transaction against the embeddings that represent the different aspects of the emerging pattern. Based on the comparison (e.g., whether the similarity between the transaction and a portion of the emerging pattern exceeds a threshold), the AI model may determine a classification for the transaction (e.g., a fraudulent transaction, a non-fraudulent transaction, etc.). The AI model may then generate a response to the query based on the classification. In some embodiments, the response includes a value or a phrase in a natural language.

In some embodiments, after providing the response, the AI model continues to interact with a user (e.g., the person who submitted the classification request, etc.). For example, if the user is an agent (e.g., an employee, etc.) of the service provider, the classification system may provide a user interface (e.g., a chat interface) that enables the user to interact with the AI model. The user may submit one or more follow-up queries related to the transaction classification to the AI model. For example, if the transaction is classified by the AI model as a fraudulent transaction, the user may inquire about a reason for such a classification, and the AI model may provide the reason to the user in a natural language format.

In some embodiments, the AI model uses different techniques to determine the reason or reasons for a classification of a transaction. For example, if the classification of the transaction was made by one of the ML models, the AI model may determine (e.g., calculate, etc.) a SHAP (Shapley Additive exPlanations) value for each of the input features associated with the ML model, and may identify one or more input features (e.g., the transaction amount feature, the network address feature, etc.) that contributed the most to the classification of the transaction based on the SHAP values. If the classification of the transaction was made by the AI model, the AI model then determines internally how the AI model arrives at the classification, and identifies one or more contributing factors for the classification. The AI model may then provide an explanation of the classification to the user via the user interface.

When the transaction is determined to correspond to the emerging pattern, the AI model may classify the transaction based on the embeddings. However, as discussed herein, the flexibility and processing capability of the AI model comes at a cost of increased consumption of computer processing resources. As such, it is generally advantageous to offload the classification task to the ML models if possible. In order to help the ML models to learn and adapt to the newly emerging patterns so that the ML models can perform transaction classification based on the new pattern, the AI model may assist in training the ML models using the transactions that correspond to the new pattern. In some embodiments, after classifying the transaction that corresponds to the emerging pattern, the AI model generates new training data based on the transaction and the classification, and uses the new training data to train the one or more ML models such that the ML models learns and adapts to the new patterns. This way, the AI model can subsequently use the ML models to classify transactions that correspond to the emerging pattern, which further improves the processing efficiency of the classification system.

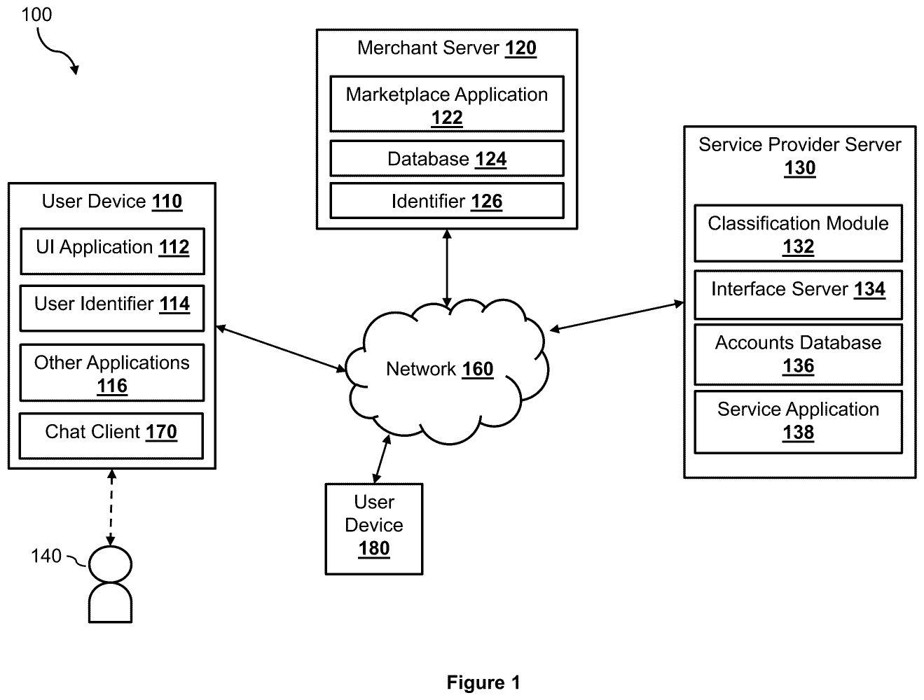

FIG. 1 illustrates an electronic transaction system 100, within which the AI model framework may be implemented according to one or more embodiments of the disclosure. The electronic transaction system 100 includes a service provider server 130, a merchant server 120, and user devices 110 and 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online purchase transaction with the merchant server 120 via websites hosted by, or mobile applications associated with, the merchant server 120. The user 140 also logs in to a user account to access account services or conduct electronic transactions (e.g., data access, account transfers or payments, etc.) with the service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may also include a chat client 170 for facilitating online chat sessions with another chat client (e.g., a chat client of another device, such as the user device 180, the conversation module 132 of the service provider server 130, etc.). The chat client 170 may be a software application executed on the user device 110 for providing a chat client interface for the user 140 and for exchanging (e.g., transmitting and receiving) messages with the other chat client (either via a peer-to-peer chat protocol or via a chat server). For example, during an online chat session with the classification module 132, the chat client 170 presents a chat interface that enables the user 140 to input data (e.g., text data such as utterances, audio data, multi-media data, etc.) for transmitting to the classification module 132. The chat interface of the chat client 170 may also present messages that are received from the classification module 132. In some embodiments, the messages is presented on the chat client interface in a chronological order according to a chat flow of the online chat session. The chat client 170 may be an embedded application that is embedded within another application, such as the UI application 112. Alternatively, the chat client 170 may be a stand-alone chat client program (e.g., a mobile app such as WhatsApp®, Facebook® Messenger, iMessages®, etc.) that is not associated with any other software applications executed on the user device 110.

The user device 110, in various embodiments, includes other applications 116 as may be desired in one or more embodiments of the present disclosure to provide additional features available to the user 140. In one example, such other applications 116 include security applications for implementing client-side security features, programmatic client applications for interfacing with appropriate application programming interfaces (APIs) over the network 160, and/or various other types of generally known programs and/or software applications. In still other examples, the other applications 116 interface with the user interface application 112 and/or the chat client 170 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.). In another example, the user 140 may use the input component to interact with the chat client 170 (e.g., to provide utterances to be transmitted to other chat clients, to a chat server, etc.). The user 140 may transmit questions/inquiries, and/or requests for performing certain tasks/transactions using the input component. In some embodiments, if the chat client 170 is integrated within another application (e.g., the UI application 112, etc.), the chat client may automatically access account data of the user via a platform (e.g., a website, etc.) accessed by the UI application, and may provide the relevant account data to another chat client or a chat server for performing the tasks/transactions.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in the merchant database 124. The merchant server 120, in one embodiment, includes at least one merchant identifier 126, which may be included as part of the one or more items or services made available for purchase so that, e.g., particular items and/or transactions are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, is configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information includes private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user has identity attributes stored with the service provider server 130, and the user has credentials to authenticate or verify identity with the service provider server 130. User attributes may include personal information, banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a classification module 132 that implements the classification system using the AI model framework as discussed herein. In some embodiments, the classification module 132 performs classification of data (e.g., transactions) for the service provider server 130. For example, the service provider server 130 may receive a transaction request from a user (e.g., the user 140, etc.) via the interface server 134 or via a chat interface connected to the chat client of the user device. The transaction request may correspond to different types of transactions, such as a login transaction for logging in to an account of a user, a purchase transaction for purchasing an item from a merchant associated with the merchant server 120, a payment transaction for transmitting funds to another account, a dispute transaction for initiating a dispute of a previously conducted purchase transaction, etc. In some embodiments, the service provider server 130 requests, directly or indirectly, the classification module 132 to classify the transaction (e.g., determining whether the transaction is a fraudulent transaction or a non-fraudulent transaction) before processing the transaction. In some embodiments, the service provider server processes the transaction based on the classification provided by the classification module 132. For example, the service provider server 130 authorizes or denies the transaction or requests additional information from the user based on the classification.

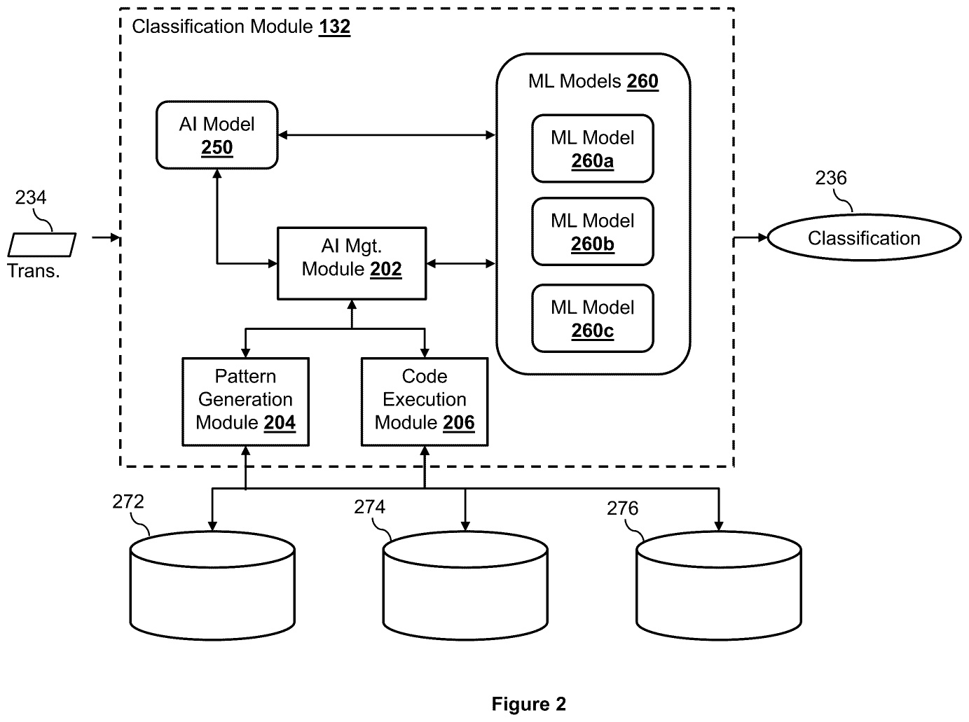

FIG. 2 illustrates a block diagram of the classification module 132 according to an embodiment of the disclosure. The classification module 132 includes an AI management module 202, a pattern generation module 204, a code execution module 206, and AI model 250, and multiple ML models 260 (including ML models 260a, 260b, and 260c). In some embodiments, each one of ML models 260 are configured and trained to perform the classification task. For example, each of the ML models 260 are configured to accept input values associated with attributes of a transaction, and generate an output value representing a classification prediction of the transaction based on the input values. In some embodiments, each of the ML models 260 are implemented using different computer structures (e.g., different types of artificial neural networks, etc.) and/or are trained using different training data such that each ML model learns different patterns (e.g., different types of fraudulent transaction patterns, etc.) for classifying transactions.

In some embodiments, each of the ML models 260 are trained using training data associated with a different time period. For example, the ML model 260a is trained using training data associated with a first time period (e.g., transactions conducted 5 years ago, etc.), the ML model 260b is trained using training data using a second time period (e.g., transactions conducted 2 years ago, etc.), and the ML model 260c is trained using training data using a third time period (e.g., transactions conducted 6 months ago, etc.).

In some embodiments, each of the ML models 260 is trained using training data associated with a different fraud tactic. For example, the ML model 260a is trained using training data associated with a first fraud tactic (e.g., chargeback frauds, etc.), the ML model 260b is trained using training data using a second fraud tactic (e.g., account-take-over fraud, etc.), and the ML model 260c is trained using training data using a third fraud tactic (e.g., mass payment fraud, etc.).

As discussed herein, the service provider server 130 (or a human analyst associated with the service provider server 130) may transmit a request to classify a transaction 234 to the classification module 132. In some embodiments, the AI management module 202 determines data that is related to the transaction 234. For example, the AI management module 202 derives first data associated with the transaction 234 based on the request, such as a transaction type of the transaction 234, identities of the parties involved in the transaction 234, network address(es) used to conduct the transaction 234, a transaction amount, a time of the day, etc. The AI management module 202 also uses the code execution module 206 to retrieve second data related to the transaction 234. For example, the code execution module 206 generates application programming interface (API) calls or queries to one or more of the databases 272, 274, and 276 to retrieve information associated with a party involved in the transaction 234 (e.g., demographics of the party, an age, a profile, etc.), past transactions conducted through a use account associated with the transaction 234, etc.

In some embodiments, the AI management module 202 uses the pattern generation module 204 to generate pattern information of any emerging fraud patterns. Emerging fraud patterns are patterns that recent transactions conducted through the service provider server 130 may exhibit, but are not recognizable by any one of the ML models 260. In some embodiments, instead of directly using one of the ML models 260 to classify the transaction, the AI management module 202 generates a prompt for the AI model 250 based on the data related to the transaction 234 (e.g., the first data and the second data, etc.) and the pattern information. The AI management module 202 then provides the prompt to the AI model 250. In some embodiments, the AI model 250 is configured to process a transaction classification request based on the prompt. For example, based on the characteristics of the transaction 234 and any emerging patterns, the AI model 250 either uses one or more of the ML models 260 to classify the transaction 234 or independently classifies the transaction 234 based on the data related to the transaction and the pattern information without using any one of the ML models 260. Based on processing the transaction classification request, the AI model 250 generates a classification output 236 for the transaction 234. The AI model 250 then provides the output to other computer modules (a module associated with the service provider server 130 or a user device such as the user device 180).

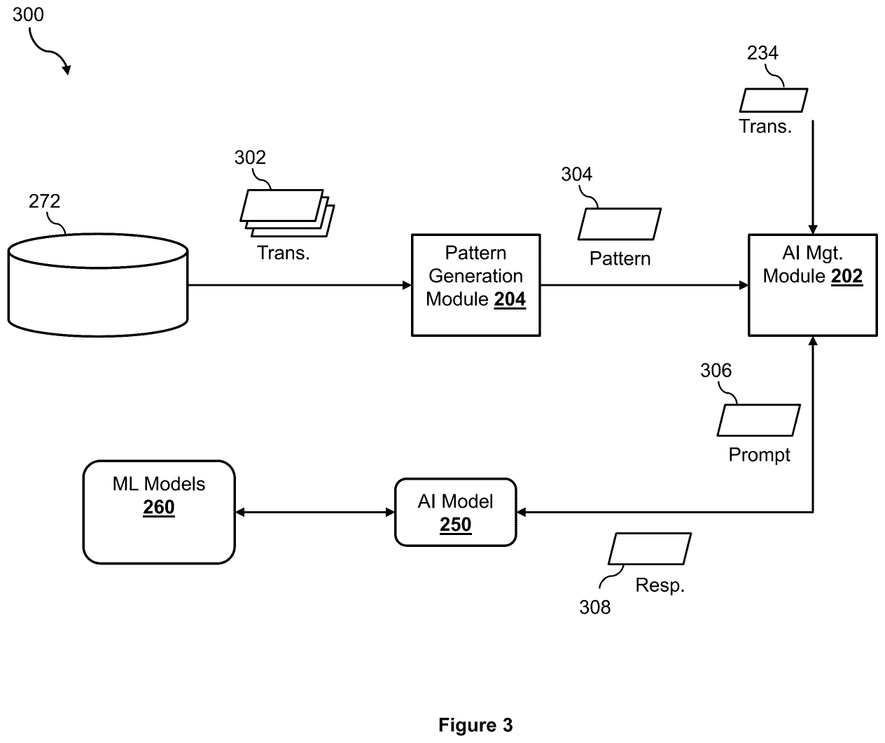

FIG. 3 illustrates an example data flow 300 for classifying a transaction according to various embodiments of the disclosure. As shown in FIG. 3, the pattern generation module 204 may generate pattern information 304 based on transaction data of recent transactions 302 conducted with the service provider server 130 and retrieved from the database 272. In some embodiments, the pattern generation module 204 monitors the transactions conducted with the service provider server 130 over a time period. For example, the pattern generation module 204 stores transactions conducted with the service provider server 130 in the database 272. The pattern generation module 204 may then retrieve transactions that have been conducted with the service provider server 130 within a particular period of time (e.g., the past month, the past two months, etc.). The particular period of time may be determined based on an amount of transactions being conducted with the service provider server 130, an event such as an increased rate of certain activities (e.g., an increased rate in chargeback requests, an increased rate in detected fraudulent transactions, etc.).

In some embodiments, the pattern generation module 204 detects any emerging patterns based on analyzing the transactions 302. For example, the pattern generation module 204 performs one or more clustering analyses to the transactions 302 conducted with the service provider server 130. The pattern generation module 204 determines that one or more clusters of transactions are associated with one or more emerging patterns that are not recognizable by any one of the ML models 260. For example, the pattern generation module 204 determines a false positive rate and/or a false negative rate of the ML models 260 in classifying transactions within each of the clusters. If the false positive rate and/or the false negative rate of the ML models 260 in classifying transactions within a particular cluster exceed a threshold, the pattern generation module 204 may determine that the transactions within the particular cluster exhibit a pattern that is not recognizable by the ML models 260.

The pattern generation module 204 may then generate pattern information 304 associated with the emerging pattern based on the transactions 302 (or a portion of the transactions 302 within the particular cluster). For example, the pattern generation module 204 generates a representation of at least a portion of the transactions 302 that are related to the emerging pattern (e.g., a summarization of the attribute values associated with the portion of the transactions 302).

In some embodiments, the pattern generation module 204 analyzes the transactions that are related to the emerging pattern, and selects a subset of the transactions that are representative of the emerging pattern (e.g., transactions that have distinct attribute values from each other, transactions that have attribute values closer to the average of the transactions related to the emerging pattern, etc.). The pattern generation module 204 may also generate embeddings (e.g., vectors within a multi-dimensional space, etc.) based on the selected transactions, such that the embeddings may accurately represent the emerging pattern. Since the transactions corresponding to the emerging pattern may be associated with different classifications (e.g., fraudulent transactions, non-fraudulent transactions, etc.), the pattern generation module 204 may generate embeddings associated with transactions of a first type (e.g., fraudulent transaction) and embeddings associated with transactions of a second type (e.g., non-fraudulent transaction).

In some embodiments, the pattern generation module 204 also analyzes the attribute values of the transactions that are related to the emerging pattern. The pattern generation module 204 may derive data associated with the emerging pattern based on the attribute values, such as ranges or categories associated with one or more of the attributes (e.g., a range of network addresses, one or more countries from which the transaction is initiated, a software model/version, a range of transaction amounts, etc.). In some embodiments, the pattern generation module 204 also generates embeddings based on the pattern information. The pattern generation module 204 may use the embeddings to generate the pattern information 304. In some embodiments, the pattern generation module 204 stores the pattern information 304 in a data storage, such as the database 272.

In some embodiments, the pattern generation module 204 continues to monitor (continuously or at predetermined or triggered times) the transactions conducted with the service provider server 130, and may generate additional pattern information corresponding to newly emerging patterns using the techniques disclosed herein. As such, the pattern information 304 may include multiple emerging patterns corresponding to transactions conducted over different time periods.

In some embodiments, when the AI management module 202 receives a request to classify the transaction 234, the AI management module 202 obtains data related to the transaction 234, using techniques disclosed herein. The AI management module 202 may also obtain the pattern information 304 generated by the pattern generation module 204. In some embodiments, the AI management module 202 generates a prompt 306 for the AI model 250 based on the request, the data related to the transaction 234, and the pattern information 304. The AI management module 202 may provide the prompt 306 to the AI model 250. In some embodiments, when multiple emerging patterns have been detected, the AI management module 202 selects one or more of the emerging patterns to be included in the prompt 306 for the AI model 250 in order to improve the efficiency of the AI model 250 in processing the transaction 234. For example, the AI management module 202 may analyze one or more attribute values associated with the transaction 234 (e.g., a location at which the transaction 234 was initiated, a time of day when the transaction 234 was initiated, etc.), and select one or more emerging patterns that are likely to correspond to the transaction 234, and include only the pattern information associated with the selected emerging pattern(s), but not pattern information associated with other emerging patterns, in the prompt 306.

Upon receiving the prompt 306, the AI model 250 may first determine whether the transaction 234 corresponds to the emerging pattern(s) based on the pattern information 304. For example, the AI model 250 may analyze the transaction 234 (e.g., the attribute values associated with the transaction 234, such as the data obtained by the AI management module 202 and included in the prompt 306), and determine whether the transaction 234 corresponds to the emerging pattern(s). If the AI model 250 determines that the transaction 234 does not correspond to the emerging pattern, the AI model 250 may determine that the ML models 260 may be capable of classifying the transaction 234 with an acceptable accuracy (e.g., an accuracy level that exceeds an accuracy threshold, etc.). Since the ML models 260 typically consume less computer processing resources than the AI model 250 to perform the classification task, the AI model 250 may then choose to instruct the ML models 260 to classify the transaction 234. For example, the AI model 250 may generate an application programming interface (API) call (e.g., a function call, etc.) for the ML models 260. The API call may include the data associated with and/or related to the transaction 234. The AI model 250 then transmits the API call to the ML models 260, to instruct the ML models 260 to classify the transaction 234.

The ML models 260 may generate an output that indicates a classification of the transaction 234. Upon receiving the output, the AI model 250 may generate a response 308 to the query (e.g., the classification request, etc.) based on the output, and may provide the response 308 to a requesting module (e.g., the module that submitted the classification request). As discussed herein, since the AI model 250 can generate output that is not limited to any fixed format, the AI model 250 may generate the response 308 that includes a phrase (or a sentence) in a natural language.

On the other hand, if the AI model 250 determines that the transaction 234 corresponds to the emerging pattern based on the pattern information 304, the AI model 250 may determine that the ML models 260 is not capable of classifying the transaction 234 with an acceptable accuracy (e.g., an accuracy level that is below the accuracy threshold, etc.). In that case, the AI model 250 may choose to perform a classification prediction for the transaction 234 without using the ML models 260. The AI model may classify the transaction 234 based on the data related to the transaction 234 and the pattern information 304 (e.g., the embeddings, etc.) that represents the emerging pattern. For example, the AI model 250 may also generate embeddings based on the attribute values associated with the transaction 234, and may compare the embeddings of the transaction 234 against the embeddings that represent the emerging pattern. Based on the comparison (e.g., whether the similarity between the transaction and the emerging pattern exceeds a threshold), the AI model 250 may determine a classification for the transaction 234 (e.g., a fraudulent transaction, a non-fraudulent transaction, etc.). The AI model 250 may generate the response 308 to the query based on the classification.

When the classification request is submitted (directly or indirectly, such as part of a transaction request) by a user of a device (e.g., the user of the user device 180), the AI management module 202 may provide the response 308 to the device 180. In some embodiments, the AI management module 202 enables the user of the user device 180 to interact with the classification module 202 via a chat interface. For example, the AI management module 202 may use a chat server (e.g., a chat server of the service provider server 130 or a third-party chat server) to establish a chat session with a chat client of the user device 180. In some embodiments, the AI management module 202 receives the classification request from the user via the chat session. As such, the AI management module 202 may provide the response 308 to the user device 180 via the chat session.

After providing the response 308, the AI model 250 of some embodiments continues to interact with the user. For example, the user may submit one or more follow-up queries related to the classification of the transaction 234 to the AI model 234. If the transaction 234 is classified by the AI model 250 as a fraudulent transaction, the user may inquire about a reason for such a classification, and the AI model 250 may provide the reason to the user in a natural language format.

In some embodiments, the AI model 250 uses different techniques to determine the reason for a classification of a transaction. For example, if the classification of the transaction was made by one of the ML models 260, the AI model 250 determines (e.g., calculate, etc.) a SHAP value for each of the input features associated with the ML model, and identifies one or more input features (e.g., the transaction amount feature, the network address feature, etc.) that contributed the most (e.g., exceeding a threshold) to the classification of the transaction 234 based on the SHAP values. If the classification of the transaction 234 was made by the AI model 260, the AI model 260 may determine internally how the AI model 260 arrives at the classification, and identify one or more contributing factors for the classification. The AI model 260 may then provide an explanation of the classification to the user via the user interface.

When the transaction 234 is determined to correspond to the emerging pattern, the AI model 250 may classify the transaction based on the embeddings. However, as discussed herein, the flexibility and processing capability of the AI model 250 comes at a cost of increased consumption of computer processing resources. As such, it is generally advantageous to offload the classification task to the ML models 260 if possible. In order to help the ML models 260 to learn and adapt to the newly emerging patterns so that the ML models 260 can perform transaction classification based on the new pattern, the AI model 250 may assist in training the ML models 260 using the transaction 234 that correspond to the new pattern. In some embodiments, after classifying the transaction 234 that corresponds to the emerging pattern, the AI model 250 generates new training data based on the transaction 234 and the classification (and other transactions that the AI model 250 has processed for the service provider server 130). For example, the AI model 250 may include attribute values associated with the transaction 234 in a training data record, and may use the classification as a label for the training data record. The AI model 250 and/or the AI management module 202 may then use the new training data to train the ML models 260. For example, the training data record corresponding to the transaction 234 may be fed into the ML models 260, and the label may be used to provide feedback for the ML models 260, such that the ML models 260 can manipulate/adjust the internal parameters based on the training data. Based on the training, the ML models 260 may learn and adapt to the emerging pattern. This way, the AI model 250 can subsequently use the ML models 260 to classify transactions that correspond to the emerging pattern, which further improves the processing efficiency and accuracy of the classification module 132.

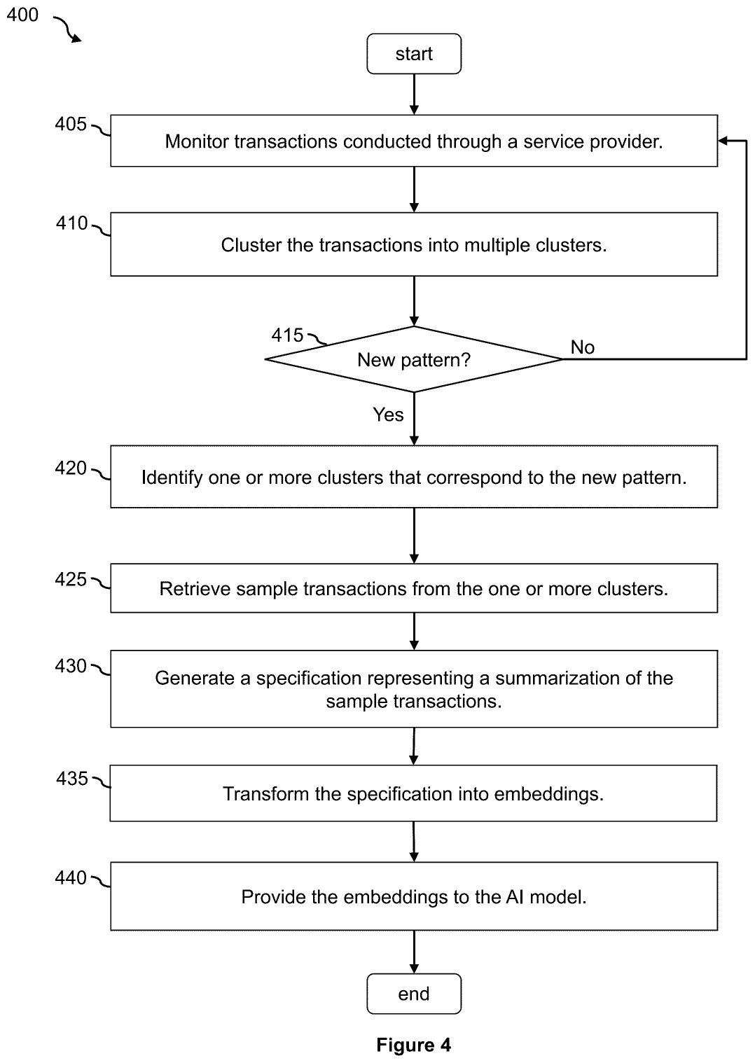

FIG. 4 illustrates a process 400 for generating pattern information of an emerging pattern for an AI model according to various embodiments of the disclosure. In some embodiments, at least a portion of the process 400 is performed by the classification module 132, although one or more steps may be performed by one or more of the components/devices/modules/systems described herein. The process 400 begins by monitoring (at step 405) transactions conducted through a service provider and clusters (at step 410) the transactions into multiple clusters. For example, the pattern generation module 204 monitors transactions that conducted with the service provider server 130. In some embodiments, the pattern generation module 204 stores the transactions in a data storage (e.g., the database 272). After detecting and storing a number of transactions being conducted with the service provider server 130 (e.g., 1,000 transactions, 5,000 transactions, etc.), the pattern generation module 204 analyzes the transactions stored in the data storage to determine if a new pattern of fraud transactions has emerged. For example, the pattern generation module 204 may cluster the transactions into multiple clusters based on the attribute values associated with the transactions. As such, transactions with similar attribute values will be grouped together in the same cluster, and transactions with different attribute values will be grouped into different clusters. If a transaction cannot be grouped into an existing cluster, that transaction may be classified as or identified as a candidate for a new pattern.

At step 415, the pattern generation module 204 determines (at step 415) whether a new pattern of fraud transactions is detected. If no new pattern is detected, the pattern generation module 204 reverts back to the step 405 and continues monitoring, continuously, periodically, or dynamically (such as during high volume purchasing periods like Christmas), new transactions conducted with the service provider. On the other hand, if a new pattern is detected at the step 415, the pattern generation module 204 identifies (at step 420) one or more clusters that correspond to the new pattern and retrieves (at step 425) sample transactions from the one or more clusters. For example, the pattern generation module 204 analyzes the different clusters of transactions and determines if any of the clusters exhibit patterns that are not recognizable by the ML models (e.g., not previously presented to or used as training data for the ML model(s)). In some embodiments, the pattern generation module 204 determines a false negative rate for each cluster of transaction. A false negative rate refers to the percentage of transactions that have been classified by the ML models 260 as non-fraudulent, but are in fact fraudulent. For example, the pattern generation module 204 may use the ML models 260 to determine a set of transactions within a cluster that is non-fraudulent. The pattern generation module 204 may then determine a number of transactions within the set of transactions that are labeled (determined by the service provider server 130 subsequently) as fraudulent, and calculate a ratio between the number of transactions that are labeled as fraudulent to the total number of transactions that were predicted as non-fraudulent by the ML models 260. A high false negative rate may suggest that the transactions in the cluster exhibit a pattern that is not recognized or used by the ML models 260. As such, the pattern generation module 204 may detect a new pattern of fraud transactions has emerged if one or more of the clusters have a false negative rate exceeding a threshold.

If a new pattern is detected, the pattern generation module 204 may identify which cluster(s) includes the transactions that exhibit the new pattern, and may retrieve sample transactions from the clusters. The sample transactions may be representative of the transactions in the cluster. For example, the sample transactions may include attribute values that are representative of the transactions in the cluster (e.g., an attribute value that is a minimum value, a maximum value, an average value, a mean value, of the transactions in the cluster, etc.). The pattern generation module 204 may also generate representations for the sample transactions (e.g., embeddings, etc.).

At step 430, the pattern generation module 204 generates a specification representing a summarization of the sample transactions and transforms (at step 435) the specification into embeddings. For example, the pattern generation module 204 may generate different data for the pattern, such as a range of values (e.g., a range of transaction amounts, a range of network addresses, etc.), or categories (e.g., one or more countries from which the transaction is initiated, one or more device models, one or more software models used to initiate the transaction, etc.). The pattern generation module 204 may then transform the data into embeddings (e.g., vectors in a multi-dimensional space, etc.).

At step 440, the pattern generation module 204 provides the embeddings to the AI model. For example, the pattern generation module 204 may provide the embeddings to the AI management module 202. Upon receiving a request to classify a transaction, the AI management module 202 may generate a prompt based on data related to the transaction and the embeddings associated with the new pattern, and provide the prompt to the AI model 250. The AI model 250 is then trained with the new pattern that enables a more accurate classification of the transaction based on the new pattern.

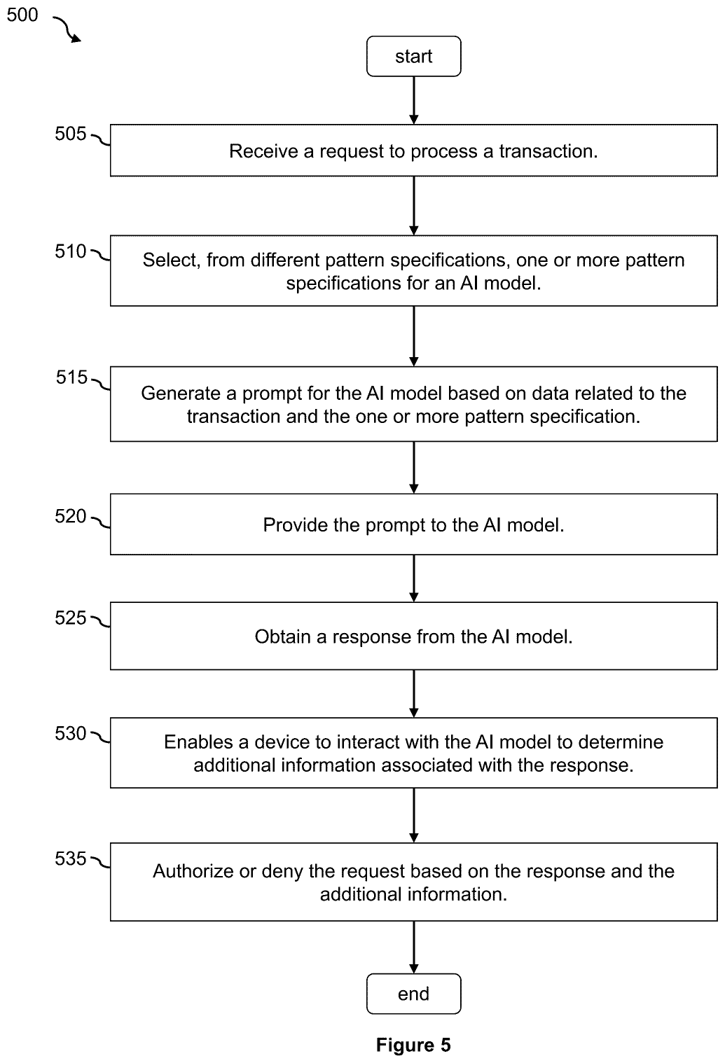

FIG. 5 illustrates a process 500 for using the adaptive AI model framework to process a transaction according to various embodiments of the disclosure. In some embodiments, at least a portion of the process 500 is performed by the classification module 132, although one or more steps may be performed by one or more of the components/devices/modules/systems described herein. The process 500 begins by receiving (at step 505) a request to process a transaction. For example, the service provider server 130 may receive a request for processing a transaction from a user device (e.g., the user device 110) via the interface server 134. The transaction can be any type of electronic transactions, such as a login transaction, a purchase transaction, a payment transaction, a data access transaction, etc. In some embodiments, before processing the transaction, the service provider server 130 may send a request to classify the transaction to the classification module 132. The service provider server 130 may process the transaction based on a classification determined by the classification module 132 for the transaction.

The AI management module 202 selects (at step 510), from different pattern specifications, one or more pattern specifications for an AI model, such as the one trained above and discussed with respect to FIG. 4, and generates (at step 515) a prompt for the AI model based on data related to the transaction and the one or more pattern specification. For example, upon receiving the request to classify a transaction, the AI management module 202 may obtain pattern information related to one or more emerging patterns that was generated by the pattern generation module 204. The one or more emerging patterns may include patterns that are determined to be unrecognizable by the ML models 260, e.g., not previously presented to, trained with, or used by the ML models 260. In some embodiments, the AI management module 202 may obtain data related to the transaction, and may generate a prompt for the AI model 250 based on the data related to the transaction and the pattern information related to the emerging patterns.

The AI management module 202 then provides (at step 520) the prompt to the AI model and obtains (at step 525) a response from the AI model. For example, after generating the prompt, the AI management module 202 may provide the prompt to the AI model 250. The AI model 250 may perform a classification task for the transaction based on the prompt, and may return a response that indicates a classification of the transaction (e.g., whether the transaction is fraudulent or not, etc.).

After obtaining the response, the AI management module 202 enables (at step 530) a device to interact with the AI model to determine additional information associated with the response and authorizes or denies (at step 535) the request based on the response and the additional information. For example, the AI management module 202 may establish a chat session with a device (e.g., the user device 180) that submits the classification request. The chat session enables a user of the device to communicate with the AI model 250. For example, the user may submit additional queries to the AI model 250 via the chat session. The user may inquire about the reasons for a particular classification of the transaction. The AI model 250 may then generate a reason for the classification of the transaction, and may provide the reason to the device via the chat session. For example, if the AI model 250 uses one or more of the ML models 260 to classify the transaction, the AI model 250 may determine SHAP values that indicate, for each input feature of the one or more ML models 260, a contribution of the input feature to the classification of the transaction. The AI model 250 may identify one or more input features that contribute the most to the classification of the transaction based on the SHAP values, and may generate the response based on the one or more input features. If the AI model 250 classifies the transaction based on the pattern information included in the prompt, the AI model 250 may determine the attributes of the transaction that contribute most to the classification, and may generate the response based on the attributes. The AI model 250 may provide the reason to the device via the chat session. In some embodiments, the AI management module 202 may provide the classification of the transaction to a module within the service provider server 130 (e.g., the service application 138, etc.), such that the module may process (e.g., authorize, deny, request for additional information, etc.) the transaction based on the classification.

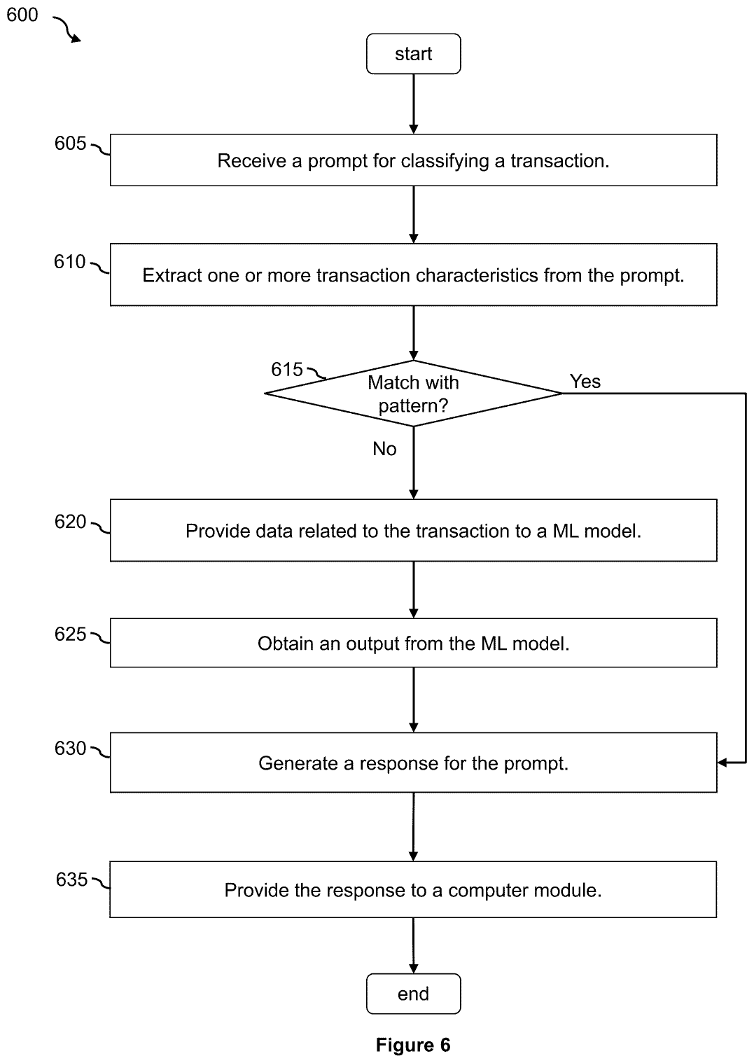

FIG. 6 illustrates a process 600 for using the adaptive AI model framework to classify a transaction according to various embodiments of the disclosure. In some embodiments, at least a portion of the process 600 may be performed by the AI model 250, although one or more steps may be performed by one or more of the components/devices/modules/systems described herein. The process 600 begins by receiving (at step 605) a prompt for classifying a transaction. For example, the AI model 250 may receive a prompt from the AI management module 202. The prompt may include data related to a transaction being classified, and pattern information related to one or more emerging patterns.

At step 610, the AI model 250 extracts one or more transaction characteristics from the prompt and determines (at step 615) if the transaction matches with the emerging patterns based on the transaction characteristics. For example, when the pattern information includes embeddings that represent the emerging pattern(s), the AI model 250 may generate embeddings that represent the transaction based on the attribute values associated with the transaction. The AI model 250 may compare the embeddings associated with the transaction against the embeddings associated with the emerging pattern(s). If the similarity between the embeddings exceeds a threshold (e.g., the distance between the embeddings is within a threshold distance, etc.), the AI model 250 may determine that the transaction corresponds to the emerging patterns. On the other hand, if the similarity between the embeddings is below a threshold (e.g., the distance between the embeddings exceeds the threshold distance, etc.), the AI model 250 may determine that the transaction does not correspond to the emerging patterns.

If it is determined that the transaction corresponds to the emerging patterns, the AI model 250 proceeds to step 630 and generates a response for the prompt. For example, the AI model 250 may perform a classification task on the transaction based on the attribute values associated with the transaction and the pattern information. The AI model 250 may then generate a response based on the classification of the transaction.

On the other hand, if it is determined that the transaction does not correspond to the emerging pattern(s), the AI model 250 proceeds to provides (at step 620) data related to the transaction to a ML model and obtains (at step 625) an output from the ML model. For example, the AI model 250 may generate an instruction (e.g., an API call, etc.) for the ML models 260. The instruction may include attribute values associated with the transaction. The AI model 250 may transmit the instruction to the ML models 260. Based on the instruction, the ML model 260 may generate an output value indicating a classification of the transaction, and transmit the output value back to the AI model 250. The AI model 250 may generate the response based on the output value from the ML models 260.

The AI model 250 then provides (at step 635) the response to a computer module. For example, the AI model 250 may transmit the response to a device of a user (e.g., the user device 180) via a chat interface. The user may then continue to interact with the AI model 250 regarding the classification of the transaction. In some embodiments, the AI model 250 may transmit the response to a computer module, such as the service application 138, such that the service application 138 can process the transaction based on the classification.

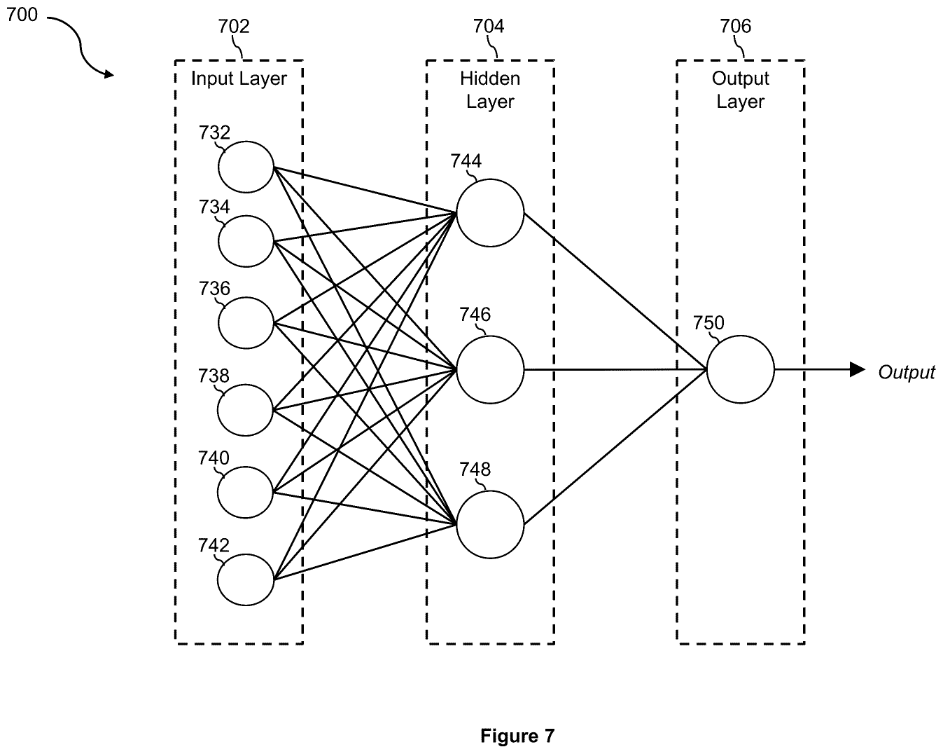

FIG. 7 illustrates an example artificial neural network 700 that may be used to implement a machine learning model, such as the AI model 250 and the ML models 260a, 260b, and 260c. As shown, the artificial neural network 700 includes three layers—an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement the AI model 250, the nodes in the input layer 702 may correspond to different parameters and/or attributes of a prompt (which may be generated based on the data related to a transaction and pattern information associated with one or more emerging patterns). In another example, when the artificial neural network 700 is used to implement any one of the ML models 260, the nodes in the input layer 702 may correspond to different attributes associated with a transaction.

In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, a prediction, etc.) for the artificial neural network 700. The number of nodes in the output layer depends on the nature of the task being addressed. For example, in a binary classification problem, the output layer may consist of a single node representing the probability of belonging to one class (as in the example shown in FIG. 7). In a multi-class classification problem, the output layer may have multiple nodes, each representing the probability of belonging to a specific class. When the artificial neural network 700 is used to implement the AI model 250 or any one of the ML models 260, the output node 750 may be configured to generate a classification of a transaction, indicating whether the transaction is a fraudulent transaction or not.

In some embodiments, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

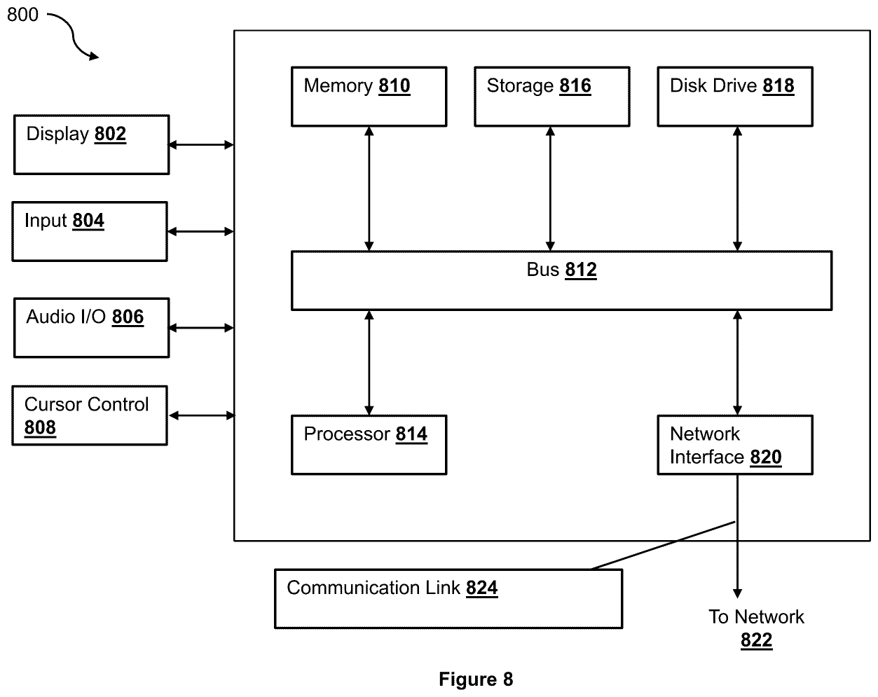

FIG. 8 is a block diagram of a computer system 800 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 1100 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the data classification functionalities described herein, for example, according to the processes 400, 500, and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
receive, from a user device, a request to process a first transaction through a service provider;
access (i) first data related to the first transaction and (ii) second data representing a first transaction pattern, the second data generated based on a plurality of second transactions conducted through the service provider;
generate embeddings representing the plurality of second transactions based on the second data;
generate a prompt for an artificial intelligence (AI) model based on the request, the first data related to the first transaction, and the embeddings; and
obtain a response from the AI model based on the prompt, wherein the response indicates a classification of the first transaction.

2. The system of claim 1, wherein executing the instructions further causes the system to:
determine, by the AI model, whether the first transaction corresponds to the first transaction pattern based on the first data and the embeddings.

3. The system of claim 2, wherein the AI model is communicatively coupled with one or more machine learning (ML) models, and wherein executing the instructions further causes the system to:
in response to determining that the first transaction does not correspond to the first transaction pattern, provide, by the AI model, the first data to a particular ML model from the one or more ML models;
obtain, by the AI model, an output from the particular ML model; and
generate, by the AI model, the response based on the output.

4. The system of claim 2, wherein executing the instructions further causes the system to:
in response to determining that the first transaction corresponds to the first transaction pattern, generate, by the AI model, the response based on the request, the first data, and the embeddings.

5. The system of claim 4, wherein the embeddings are first embeddings, and wherein generating the response comprises:
generating second embeddings based on the first transaction; and
comparing the second embeddings against the first embeddings.

6. The system of claim 1, wherein the plurality of second transactions were conducted through the service provider over a first time period, and wherein executing the instructions further causes the system to:
analyze a plurality of third transactions conducted through the service provider over a second time period;
detect a second transaction pattern based on analyzing the plurality of third transactions; and
generate third data representing the second transaction pattern based on the plurality of third transactions.

7. The system of claim 6, wherein executing the instructions further causes the system to:
receive a second request to perform a third transaction for a second user;
select, between the second data and the third data, the third data for generating a second prompt for the AI model based on the second request; and
generate the second prompt for the AI model based on the second request and the third data.

8. A method comprising:
receiving, from a user device, a request to process a first transaction with a service provider;
accessing, by a computer system of the service provider, data related to the first transaction based on the request;
determining, by the computer system, a transaction pattern unrecognizable by a machine learning (ML) model based on a plurality of second transactions conducted with the service provider;
generating, by the computer system, a representation of the transaction pattern based on attribute values associated with the plurality of second transactions;
generating, by the computer system, a prompt for an artificial intelligence (AI) model based on the request, the data related to the first transaction, and the representation of the transaction pattern, wherein the AI model is communicatively coupled with the ML model and configured to provide data to the ML model that enables the ML model to classify the first transaction based on the prompt; and
obtaining, by the computer system, a response from the AI model, wherein the response indicates a classification of the first transaction.

9. The method of claim 8, further comprising:
authorizing or denying the request based on the classification.

10. The method of claim 8, wherein the accessing the data comprises:
querying a database for the data based on an identifier of a user associated with the user device.

11. The method of claim 8, further comprising:
performing a clustering operation on the plurality of second transactions, wherein a plurality of clusters is generated based on the performing the clustering operation;
identifying, from the plurality of clusters, a particular cluster that corresponds to the transaction pattern; and
accessing the plurality of second transactions from the particular cluster.

12. The method of claim 8, wherein the generating the representation comprises:
extracting, from the plurality of second transactions, one or more second transactions based on a set of criteria; and
generating embeddings based on a portion of the attribute values associated with the one or more second transactions.

13. The method of claim 8, further comprising:
determining, by the AI model, whether the first transaction corresponds to the transaction pattern based on the data related to the first transaction and the representation associated with the transaction pattern.

14. The method of claim 13, further comprising:
in response to determining that the first transaction does not correspond to the transaction pattern, providing, by the AI model, the data to the ML model, wherein the ML model is configured to generate an output based on the data; and
generating, by the AI model, the response based on the output.

15. The method of claim 13, further comprising:
in response to determining that the first transaction corresponds to the transaction pattern, generating, by the AI model, the response based on the data and the representation.

16. A non-transitory machine-readable medium having stored thereon machine-readable instructions executable to cause a machine to perform operations comprising:
receiving a request to process a first transaction initiated from a user device;
obtaining data related to the first transaction based on the request;
accessing a representation of a transaction pattern unrecognizable by a machine learning (ML) model, wherein the ML model is configured to classify transactions, and wherein the representation is generated based on a plurality of second transactions associated with the transaction pattern;
generating a prompt for an artificial intelligence (AI) model based on the request, the data related to the first transaction, and the representation of the transaction pattern, wherein the AI model is communicatively coupled with the ML model and configured to assist the ML model in classifying the first transaction based on the prompt; and
obtaining a response from the AI model, wherein the response indicates a classification of the first transaction.

17. The non-transitory machine-readable medium of claim 16, wherein the operations further comprise:
determining, by the AI model, whether the first transaction corresponds to the transaction pattern based on the data and the representation.

18. The non-transitory machine-readable medium of claim 17, wherein the operations further comprise:
in response to determining that the first transaction does not correspond to the transaction pattern, providing, by the AI model, the data to the ML model, wherein the ML model is configured to generate an output based on the data;
obtaining, by the AI model, the output from the ML model; and
generating, by the AI model, the response based on the output.

19. The non-transitory machine-readable medium of claim 17, wherein the operations further comprise
in response to determining that the first transaction corresponds to the first transaction pattern, generating, by the AI model, the response based on the data and the representation, wherein the data is not provided to the ML model.

20. The non-transitory machine-readable medium of claim 19, wherein the representation is a first representation, and wherein the generating the response comprises:
generating a second representation based on the data; and
comparing the second representation against the first representation.
